(19) United States
(12) Patent Application Publication
(10) Pub. No.: US 2006/0179898 A1
(43) Pub. Date: Aug. 17, 2006

(54) Standardised testing medium for the quality of a washing, cleaning and/or drying process

(76) Inventors: Felix Frey, Horn (CH); Daniel Fah, Teufen (CH)

Correspondence Address: WILLIAM COLLARD;COLLARD & ROE, P.C., 1077 NORTHERN BOULEVARD, ROSLYN, NY, 11576, US

(21) Appl. No.: 10/550,250

(22) PCT Filed: Mar. 22, 2004
(86) PCT No.: PCT/IB04/00829

§ 371 Date: Sep. 23, 2005

(30) Foreign Application Priority Data
Mar. 25, 2003 (DE) 10313504.9

(51) Int. Cl. B08B 13/00

(52) U.S. Cl. 68/235 R; 134/113; 73/60.11

(57) ABSTRACT

A testing medium to which corresponding particles are applied in a defined density. In washing machines, the particles are detached from the testing medium by the mechanical stressing of the testing medium inside the drum, by tumbling, bending or stretching. The physical and/or chemical treatment of the testing medium inside a dishwasher, under various water jets, causes the particles to be detached from the testing medium. The number of particles remaining on the testing medium after the cleaning, washing and/or drying process is a value related to the stressing of the testing medium, and hence to the quality of cleaning and the physical and/or chemical activity of the aggregate during the process. The testing medium can be used in any aggregate which carries out at least one of these processes. Washing machines and dishwashers thus represent only an example.

The invention relates to a testing means for standardized ascertainment of the quality of a washing, cleaning and/or drying operation in an assembly, consisting of textile fabric (wovens, knits, nonwovens or the like) or two- and three-dimensional articles from the necessities of day-to-day life.

### DEFINITION

Assemblies which perform washing, cleaning and drying operations are known in the form of washing machines or dishwashers and also other washing, cleaning and drying devices (including, for example, floor cleaners).

### STATE OF THE ART

In particular for washing machines, which in general of a rotating drum, which is fed with the fabric, clothing or the like that is to be laundered, this laundry is flexed as a result of the drum rotating, and hence is subjected, together with water and detergent, to a high mechanical stress. This stress imposes a load on the textile fabric, in such a way that individual fibers and/or fiber assemblies are subjected to high mechanical stress and, as a result, tears, rips or other fiber breakages occur.

Dishwashers consist in general of a washing chamber, in which one or more jets of water rotate and so clean the ware to be washed, such as plates, glasses or cutlery or the like. In addition, detergents are increasingly acting to produce additionally, in conjunction with water, a chemical substance that removes the soiling in question from the articles to be cleaned. Particularly in the case of dishwashers, therefore, the objective is to remove the articles that were to be cleaned from the machine in as clean a condition as possible.

In order to test the quality of such washing, cleaning and/or drying machines in terms of physical and/or chemical load, particularly in the case of washing machines, relative to the ware to be cleaned or with regard to the effect of the assemblies on the textile material, provision has been made for example, in accordance with the prior art, to produce testing means which allow ascertainment of the extent of the physical and/or chemical stress to which textile fabric is exposed in the course of washing procedures in different washing machines. For this purpose it is proposed to use a testing material in the form of a fiber fabric which, beforehand, has certain holes in the fabric, which then, during the washing procedure, are enlarged by—in particular—mechanical stress correspondingly, by virtue of the individual fiber strands of the textile fibers detaching. The number of fiber strands or fibers detached is then an indicator of said load on the textile fabric during the washing, cleaning and/or drying operation. The greater the number of textile fibers or filaments detached, the greater the mechanical load.

For dishwashers as well, testing processes are known. As a general rule they consist in applying food residues in defined amounts and embodiments to the ware that is to be cleaned. Thus, for example, on porcelain plates, areas of egg white, ketchup, salad creams and butter, or else other foodstuffs, are applied using a brush. This testing-means production is repeated a number of times so that the same testing means are available for different cleaning procedures.

In the course of the actual washing, cleaning and/or drying operation, however, there are further parameters to be taken into account: for example, the detergent in question, but also the water hardness, which likewise may influence the mechanical action on the material.

A further factor is the siting position of the material to be cleaned within the device.

Additional parameters include:

1. the period of exposure;

2. the internal construction of the washing device, such as size, design, and number and shape of corresponding separating devices, for example;

3. rotational speeds of the drum and/or of the material to be washed and/or of the jet device inside a dishwasher;

4. water level;

5. the amount of the material to be washed and cleaned or dried, particularly in relation to the chamber volume;

6. the characteristics of the material to be cleaned, such as type, amount, quality and dimensions, and/or weight and composition;

7. foam height.

The critical factor for the physical and/or chemical exposure of the textile fabric is substantially the mechanical force which acts on the fabric during the washing operation. Repeated bending, stretching and flexing or dragging motions, all with the objective of washing the soil from the textiles, are deleterious to the nature and the corresponding characteristics of the textile fabric.

The mechanical exposure of the ware to be cleaned within a dishwasher, as well, is critically dependent on the mechanical force of the corresponding water jet. The greater the force of the water jet on the ware that is to be cleaned, the greater the probability that food residues will be removed accordingly. However, there are also regions not reached by these water jets, so that here, in particular, the chemical operation induced by the detergent is required to act in order to remove food residues clearly here.

Furthermore, at the present time, no processes or testing means are known for floor-cleaning machines.

The methods for ascertaining qualities of a washing, cleaning and/or drying operation by washing machines and dishwashers are very inconvenient and expensive and can be sharply distorted by chemical influences, such as bleaches, for example. Moreover, comparison with other types of investigation is very difficult, since no standardized procedure at all has been implemented.

Problem Posed

It is an object of the invention to produce a testing means and also a process by means of which it is possible to determine in a standardized fashion in particular the mechanical activity of an assembly, such as of a dishwasher and of a washing machine, for example, and the attendant mechanical and chemical exposure of a material that is to be washed, cleaned or dried.

This means that, using such a testing means and such a process, it is possible to reproduce with maximum precision the physical and/or chemical load imposed by the assembly on the material to be cleaned, and the comparison of different assemblies with one another. The testing means and also the process of the invention ought to ensure a very practical assessment.

Solution Concepts

A core concept of the invention is to produce a defined testing means on which corresponding particles are applied in a defined density. In the case of washing machines, the mechanical load on the testing means within the drum, in particular, achieved for example through flexing, bending or stretching, causes the particles to detach from the testing means. The number of particles remaining on the testing means after the cleaning, washing and/or drying procedure is a variable which correlates with the load on the testing means and hence with the physical/chemical activity of the assembly during the washing operation.

The physical and/or chemical exposure of the testing means within a dishwasher, achieved for example by means of different water jets with different pressures and also by the chemical adjuvants, causes the particles to detach from the testing means. The number of particles remaining on the testing means after the cleaning, washing and/or drying procedure is a variable which correlates with the cleaning quality and hence with the physical and/or chemical activity of the assembly during the cleaning, washing and/or drying operation.

The testing means are preferably designed so as to be suitable for all kinds of assemblies which perform washing, cleaning and/or drying operations. For example, a floor tile may have the embodiment of a testing means, in order to test floor cleaners accordingly. An alternative may consist in applying the testing means to a floor tile which has already been laid.

### ADVANTAGES OF THE INVENTION

The advantages of the invention are generally dependent on the assembly—for example washing machine or dishwasher—the testing means in question is used. For ease of comprehension, the advantages in respect of an assembly in the embodiment of a washing machine are presented first of all below. Subsequently, the advantages of the testing means and also the process of the invention are addressed in more detail in relation to the assembly in the embodiment of a dishwasher. Attention is drawn to the fact that the use of the testing means is not limited to these two assemblies. The testing means finds application in relation to any qualitative testing of an assembly that performs a washing, cleaning and/or drying operation.

Washing Machine

One preferred embodiment of the testing means in relation to the testing of the quality of a cleaning, washing and/or drying operation in the case of a washing machine is a two- or three-dimensional article in the embodiment of a carrier element arranged on which, in a defined density, are particles. These particles have the characteristic of detaching from the carrier element as a consequence of its chemical and/or physical exposure. The particles feature a defined holding force, having been applied alternatively by adhesive bonding, by fusion or otherwise. The particles themselves consist in general of plastic. As a result of the mechanical forces which come about within the washing machine (flexing, bending, stretching or the like), and in accordance with the magnitude of the forces which occur, a greater or lesser number of particles is detached. The number of particles detached or of particles remaining is ascertained accordingly and measured, and is generally taken as a measure of the mechanical load arising during the cleaning, washing and/or drying procedure. The assessment can then be made in accordance with a variety of methods, including the simple counting of a control standard or measurement, for example, in colorimetric form.

In order to produce a consumer-compatible embodiment of the testing means it is proposed, in accordance with the invention, that the carrier element be formed of a woven fabric, in plain weave for example, to which the particles, consisting for example of polyethylene, are applied. Alternatively for this purpose it is also possible to envisage the carrier element consisting of wool or another basic textile material, on which, again, corresponding particles, consisting for example of polyethylene, are arranged.

The carrier element may therefore consist of any desired materials provided that a certain surface area is ensured. It is also possible to use three-dimensional constructions formed either from the carrier material, or the testing means itself features the corresponding particles, applied in a defined density. Depending on the material to be tested, corresponding sample sections may be washed. It is also conceivable for the testing materials to be sewn or otherwise attached to existing laundry or woven textiles. Provision may be made here, for example, to attach the testing material to towels, in particular to their edge (selvedge), in order to find realistic conditions accordingly.

Dishwasher

One preferred embodiment of the testing means for dishwashers is a two- or three-dimensional article having, accordingly, the form of customary ware in this dishwasher context ware to be cleaned: for example, a plate, a mug, a glass or an item of cutlery. The particles are applied to this article with a defined holding power (applied either by adhesive bonding, by fusion or else using egg white, or otherwise).

These particles consist in general of plastic. As a result of the physical load, particularly the mechanical load produced by the applied water pressure, forces act accordingly, depending on the nature, position, and arrangement of the ware to be cleaned, and these forces detach the particles in question to a greater or lesser extent. The number of spots detached or remaining, respectively, is ascertained accordingly and measured, and is generally taken as a measure of the quality of the washing, cleaning and/or drying operation. Assessment is then made by a variety of methods, including simple counting, control standards or measurements, by colorimetry for example.

One alternative embodiment may consist in the particles being formed from food residues which are applied to a carrier material which in its turn may be applied to ware that is to be cleaned, such as a plate, a glass, a mug or an item of cutlery, for example. As a result of the physical or chemical load which occurs within the dishwasher, the various particles are removed in differing amount, so that in this way as well a highly consumer-oriented quality test can be performed.

One particularly preferred embodiment consists in the testing means, and in a two- or three-dimensional embodiment, consisting of a carrier element which consists of plastic, ceramic or glass. This carrier element, on which the corresponding particles are arranged in a predetermined density, can be shaped as desired or brought into different shapes. This carries with it the advantage that the carrier materials can be applied to freely selectable locations on the ware to be cleaned and hence, also, allow standardized measurements which may extend to angular and undercut regions, in particular, of the ware that is to be cleaned.

Furthermore, this embodiment of the testing means carries with it the advantage of being a consumer-oriented embodiment, so that the consumer finds, in the testing means, the article which is placed daily in the dishwasher.

The particles themselves may consist of a variety of materials. The core point of the invention is that the particles, of equal size or of different but in each case defined size are adhered or fused on to the article or to the carrier element in some specific way, the holding force that holds the particles on the carrier element being defined. Particularly when performing standardized series of tests, provision may be made to apply the particles using food like or food-identical adhesives.

As an alternative to this, it is also possible to provide polyester or polyamide particles. Furthermore, it is conceivable to use any desired metals, stone materials, glass or similar materials, these being applied by means of an adhesive. It is important that solely the adhesive is arranged below the particle in question.

Consequently, the following processes for application are proposed:

On the one hand it can be envisaged to apply the spots point wise or particle wise to the carrier element by means of a predetermined grid dimension. Furthermore, it may be envisaged to apply particle material correspondingly via a matrix placed over the carrier element. Moreover, it may be envisaged to apply the particles to the carrier element in defined sizes and areas by means of a structure already applied to film. Hence there are a very great number of conceivable variants for applying such particles to a fabric or to a defined carrier element.

The adhesive bonding process can be selected in accordance with the desired holding force. On the one hand, provision may be made in accordance with the invention to apply the individual particles by means of a corresponding adhesive. On the other hand, provision may be made, by spray application and/or fusion application to the carrier element, for the carrier element and the particle to enter into a defined mutual connection which has the magnitude of a corresponding holding force.

As an alternative to this, provision may be made to provide each particle with an adhesive and then to apply such particles to the carrier element in accordance with a pattern defined beforehand.

The adhesive material provided may also be egg white, so that, particularly in the field of use of the testing means with dishwashers, a consumer-oriented quality evaluation may be made.

A further embodiment may comprise carrier element and particles forming a single-piece component. In order to determine the holding force between the particle and the carrier element, it is preferred to provide the particle with a correspondingly thin cross section. As an alternative to this it is possible to provide for the insertion of a defined and predetermined intended-breakage point on the particle.

Where the testing means takes the embodiment of a carrier element, it can be attached to articles in a variety of ways and in a diversity of forms. For example, provision is made for the carrier element to be designed in strip form and to be able to be adhered, particularly in the dishwasher sector, to the ware that is to be cleaned. It can be attached to any sites on the ware and, by virtue of its flexible design, may be arranged on any desired curves and corners and also edges.

Food residues may also have already been arranged on the carrier element. These food residues may have been produced either synthetically or realistically, and then have properties which correspond to the daily use of ware to be cleaned within dishwashers.

A further embodiment of a testing means, particularly for dishwashers, may consist in the carrier element and/or the article being of circular configuration, so that it can be attached in particular to plates or else to the base of cups or glasses.

The abovementioned testing means are also suitable for assessing the quality of cleaning products in hand-washing.

Further advantageous embodiments are apparent from the description, claims, and drawings below.

### DRAWINGS

FIG. 1 shows a cross section through a testing material of the invention, consisting of a three-dimensional article in the form of a carrier element, and particles applied to the carrier element;

FIG. 2 shows a plan view of a testing means, used in washing machines, which has been subjected to a very low load;

FIG. 3 shows a plan view of a testing means, used in washing machines, which has been subjected to a low load;

FIG. 4 shows a plan view of a testing means, used in washing machines, which has been subjected to a moderate load;

FIG. 5 shows a plan view of a testing means, used in washing machines, which has been subjected to a high load;

FIG. 6 shows a diagrammatic representation of the application of a carrier material to a material which is to be cleaned and has been provided with particles;

FIG. 7 shows a diagrammatic front elevation of the applied carrier material together with the material to be cleaned, as in FIG. 6;

FIG. 8 shows a diagrammatic representation of the application of particles to a material to be cleaned.

### DESCRIPTION OF THE EXEMPLARY EMBODIMENTS

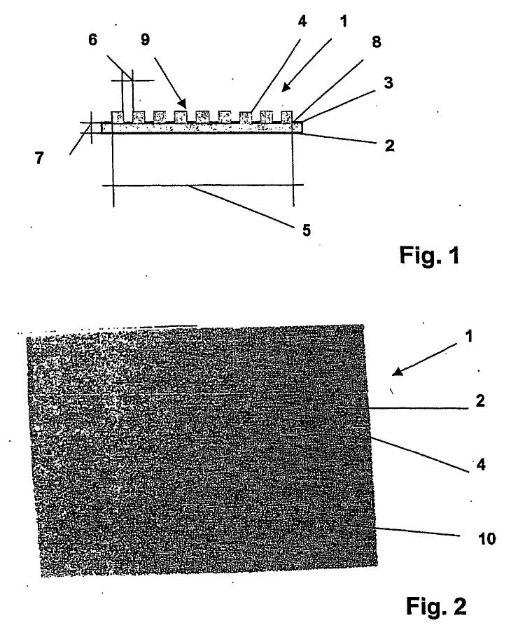

FIG. 1 shows a cross section through a testing means of the invention. This testing means 1 consists of a two- or three-dimensional article in the embodiment of a carrier element 2 and of the particles 4 arranged on the surface 3. The particles 4 are arranged in a region 5 on the surface 3 of the carrier element 2 and are at a distance 6 from one another. The thickness 7 of the carrier element 2 is arbitrary and it is envisaged preferably to use a carrier element 2 of this kind which in actual service as well, in connection for example with the quality monitoring of a washing machine, corresponds to textiles such as shirts, pants or the like.

The particles 4 are applied on their underside 8 to the surface 3 of the carrier element 2. In the interstices 9 between the individual particles there is a free space.

FIGS. 2-5 depict a carrier element 2 of this kind, with particles 4, in plan view. In particular in FIG. 2 it is apparent that there are small voids 10 which come about because a particle 4 has undergone detachment from the surface 3 of the carrier element 2. Also readily apparent is the distance 6 between the individual particles 4.

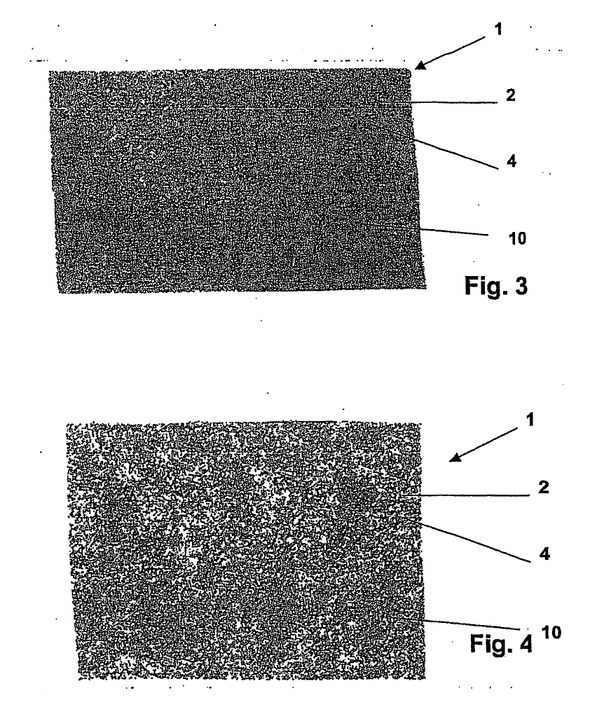

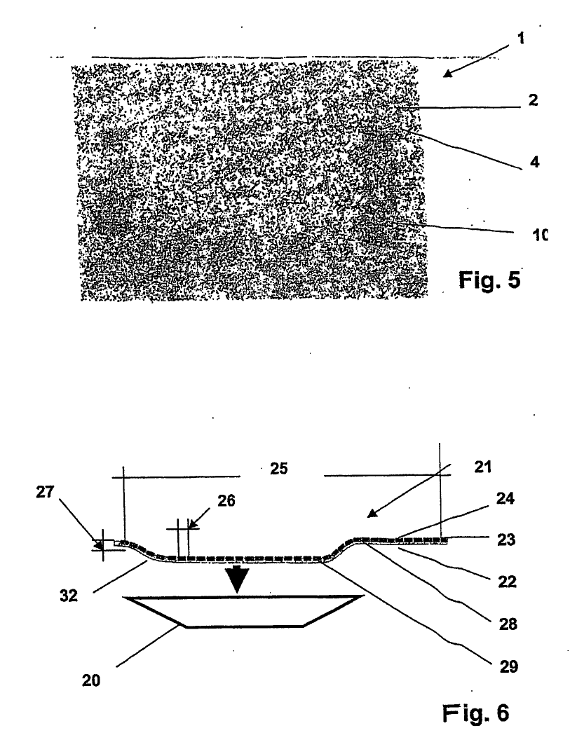

In FIG. 3 a plurality of voids 10 have already occurred, while in FIG. 5 there is a very great number of voids 10, induced by the fact that high mechanical and/or chemical stress has occurred and so the particles 4 have lost contact with the carrier element 2.

The carrier element 2 thus produced is introduced into an assembly where it is exposed in accordance with the assembly: for example a washing machine or a dishwasher. For this purpose it may be envisaged to predetermine a standard loading of the assembly and to add the testing means 1 as an additional quality testing means. The evaluation of how many voids 10 such a carrier element 2 then has can be made in a variety of ways.

The particles are preferably colored—either colored already when applied, or colored following application to the carrier element 2—such that they are very different from the background color of the surface of the carrier element and so contrast with it. On this basis, the density of the particles 4 per unit surface area can be determined analytically by means of an optical surface measurement. A variety of techniques are known from the prior art for this purpose, and require no further elucidation here.

As an alternative to the stated process, in which the number of particles 4 having detached as a result of the mechanical and/or chemical load is ascertained, may involve inserting different testing materials into the testing procedure, the different testing materials differing in that these materials are each provided with particles having different holding forces on the carrier element 2 and/or in that a different carrier element 2 is used.

Following a test procedure, the mechanical load can then be ascertained in testing means 1, which to start with still carries virtually all the particles 4.

The essential advantage of the invention is that it is possible to ascertain even at first glance, in a very simple way, how high the physical and/or chemical load has been during a washing, cleaning and/or drying operation. Even a very small number of voids 10 are readily identified very simply, and it is also possible to produce a corresponding comparison with different assemblies of the same type.

A further essential advantage is that the testing material 1 is applicable for every kind of drying, washing or cleaning. A further key point is that a test of this kind is quick and inexpensive to perform, and in particular that conclusive statements can be made regarding the mechanical load after just one to five washing procedures. Laborious secondary testing, such as the tear strength testing known from the prior art, is dispensed with entirely.

A comparison can also be readily depicted very effectively, both analytically and visually, between two different assemblies, irrespective of whether these assemblies are used for the cleaning, drying or for the washing of textile material or for the cleaning, washing and drying of kitchen- and tableware or the like. The results using the testing means are very reproducible and, above all, can be standardized. They also correspond to consumer conceptions, being able to be carried out realistically.

FIG. 6 depicts a diagrammatic representation of the application of a testing means 21 to ware 20 that is to be cleaned, a plate for example. This testing means 21 consists of a two- or three-dimensional article in the embodiment of a carrier element 22, and of the particles 24 arranged on the surface 23. The particles 24 are arranged in a region 25 on the surface 23 of the carrier element 22 and are at a distance 26 from one another. The thickness 27 of the carrier element 22 is arbitrary. The particles 24 are applied on their underside 28 to the surface 23 of the carrier element 22. In the interstices 29 between the individual particles 24 there is a free space. The carrier element 22 is preferably flexible, so that it can be adapted to the ware to be cleaned. On the side 32 facing away from the particles 24, the carrier element 22 has a bonding area for firm attachment to the ware to be cleaned.

As an alternative to this it is envisaged that the carrier element 22 be inserted into any desired mold (as depicted, for example, in FIG. 6) and cured by means of appropriate apparatus. This produces a testing means 21 which has a three-dimensional form and which then also retains said form. In this way it is possible very easily to produce mugs, cups, plates or similar products as testing means.

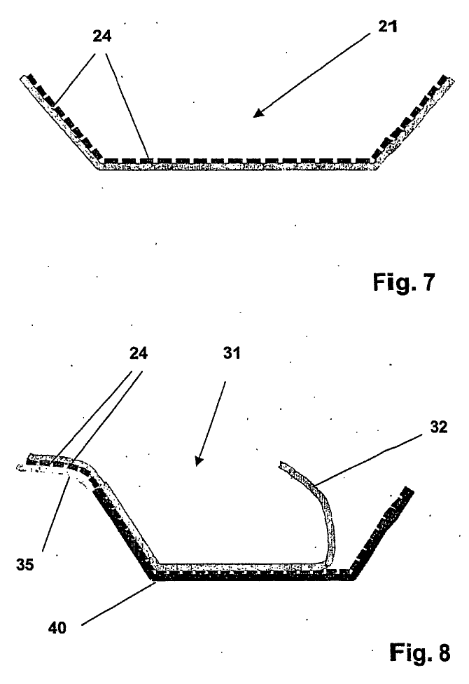

FIG. 7 depicts the results of the process step of FIG. 6. As a result of the application of the testing means 21 in this way it is possible to cover some or all of the ware to be cleaned with particles 24.

An alternative embodiment to this is depicted in FIG. 8. The testing means 31 presented in this case consists, in this exemplary embodiment, of particles 34 and a carrier element 32. The particles 34 are held in a defined density with respect to one another by means of a carrier element 32. On the side pointing away from the carrier element 32, the particles 34 have an adhesive layer which is lined with a carrier film 35. For application of the particles 34, the carrier film 35 is removed and taken off, so that the particles 34 can be applied to an article 40. As soon as the particles 34 have been applied to the surface of the article 40, the carrier element 32 can be removed. With the aid of this device the particles 34 can be mounted on any desired articles.

The testing means for standardized ascertainment of the quality of a washing, cleaning and/or drying operation can be employed in any assembly that performs at least one of the stated operations. Washing machine and dishwasher therefore constitute only a selection.

1-9. (canceled)

10. A testing device to ascertain the quality of a washing, cleaning and/or drying operation, comprising an article and particles arranged on the article in a defined density, said particles being detachable from the article by physical and/or chemical exposure.

11. The testing device of claim 10, further comprising a carrier element onto which the particles are applied, said carrier element being connected to the article.

12. The testing device of claim 11, wherein the particles are applied by means of a connection agent to the carrier element.

13. The testing device of claim 10, wherein the particles and the article are designed in a single piece.

14. The testing device of claim 13, wherein an intended-breakage point is provided between each particle and the article.

15. The testing device of claim 10, wherein the particles consist of plastic.

16. The testing device of claim 10, wherein the particles have defined sizes of at least one of the following substances: egg white, blood, ketchup or other foodstuffs.

17. The testing device of claim 10, wherein the particles are covered on one side with a carrier element which is detachable from the particles and covered on their other side with a carrier film which is detachable from the particles.

18. The testing device of claim 17, wherein the particles are provided with an adhesive for attachment to the article, said adhesive being disposed on the side covered by the carrier film.

19. The testing device of claim 11, wherein the carrier element is freely formable and is adapted to be cured in a selected shape in order to form a two- or three-dimensional structure.
